(19) United States
(12) Patent Application Publication
(10) Pub. No.: US 2026/0079466 A1
(43) Pub. Date: Mar. 19, 2026

(54) SYNCHRONIZED TIME-SERIES DATA AND EXECUTION TRACE FOR DEBUGGING PROGRAMMABLE LOGIC CONTROLLERS

(71) Applicant: Robert Bosch GmbH, Stuttgart (DE)

(72) Inventors: Emily RUPPEL, Pittsburgh, PA (US); Anthony ROWE, Pittsburgh, PA (US)

(21) Appl. No.: 18/886,148

(22) Filed: Sep. 16, 2024

(51) Int. Cl. G05B 19/05

(52) U.S. Cl. CPC G05B 19/058; G05B 2219/13142

(57) ABSTRACT

A method for synchronizing sensor data from an industrial process with program trace data from a control program executed by a programmable logic controller (PLC) controlling the industrial process. The method includes executing a control program to control industrial equipment and receiving sensor data based on physical responses from various sensors. Program trace data from the control program and sensor data is recorded during execution. The program trace data and the sensor data are time-stamped. Instances of the time-stamped program trace data and sensor data are synchronized. The synchronized data may then be replayed alongside the program trace data as the program is re-executed to allow a programmer to perform debugging.

### TECHNICAL FIELD

The present disclosure relates to programmable logic controllers (PLCs) used in an industrial setting, and more particularly, debugging control program executed by PLCs in an industrial environment.

### BACKGROUND

PLCs are widely used to control physical processes in industrial automation. Programs executed by PLCs may control industrial equipment, such as robotic arms, conveyor belts, and so on, as well as the industrial processes carried out by such equipment. After a control program for a PLC is written, it may be debugged to ensure correct operation. Such debugging solutions for PLCs include tracing data values. These data trace values may be generated by various sensors associated with the industrial equipment and the process carried out thereby.

### SUMMARY

A method for synchronizing sensor data from an industrial process with program trace data from a control program executed by a programmable logic controller (PLC) controlling the industrial process. The method includes executing a control program, using the PLC, to control industrial equipment and cause physical responses in the industrial equipment. The method further includes receiving sensor data based on the physical responses in the industrial equipment, from a plurality of sensors, wherein the plurality of sensors include at least one sensor configured to provide streaming data (e.g., a video camera), and one or more additional sensors configured to sense physical data. Program trace data from the control program and sensor data from each of the plurality of sensors is recorded during execution of the control program. The program trace data and the sensor data are time-stamped, and wherein the sensor data is periodically recorded in a capture period. The method further includes synchronizing instances of the time-stamped program trace data and instances of the time-stamped sensor data. The synchronizing includes determining, for a given instance of the time-stamped program trace data, that the given instance of the program trace data is within a time period having an upper boundary corresponding to a next consecutive given instance of the time-stamped program trace data and a lower boundary defined by a difference between the next consecutive given instance of the time-stamped program trace data and the capture period of sensor data for a corresponding one of the plurality of sensors. Based on this determining, the method further includes linking an instance of the time-stamped sensor data within the upper and lower boundaries to the time-stamped program trace data within the upper and lower boundaries. The method enables debugging the control program to generate a debugged control program. Debugging the control program includes presenting instances of the synchronized data to a user via a debugger interface and subsequently executing the debugged control program. Using synchronized data and the program trace data, the program can be replayed alongside the synchronized data display to provide a programmer or operator additional insight as to how the system is responding to program execution.

### BRIEF DESCRIPTION OF THE DRAWINGS

FIG. 1 shows a system 100 for training a neural network.

FIG. 2 shows a computer-implemented method 200 for training a neural network.

FIG. 3A shows a diagram of one embodiment of an industrial apparatus controlled by a PLC and a user interface for debugging a program executed by the PLC.

FIG. 3B shows a block diagram of one embodiment of a system for debugging a control program executable by a PLC.

FIG. 3C shows a portion of a user interface linking executed PLC code and sensor data within a period of capture of the sensor data.

FIG. 4 illustrates an example method for synchronizing sensor data and program trace data in a system for debugging a control program executable by a PLC.

FIG. 5 depicts a schematic diagram of an interaction between computer-controlled machine 510 and control system 512.

FIG. 6 depicts a schematic diagram of the control system of FIG. 1 configured to control a manufacturing machine as part of a production line.

FIG. 7 depicts a schematic diagram of the control system of FIG. 1 configured to control an imaging system, for example an MM apparatus, x-ray imaging apparatus or ultrasonic apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Debugging solutions for programmable logic controllers (PLCs) are limited to tracing data values available in the digital domain, but PLCs typically interact with the physical world. To improve the ability of operators to debug PLC code running in factories, the present disclosure is directed to a method that synchronizes the state of the physical world through external, multimodal data streams with the state of the PLC program. Operators can leverage traditional debugging tools like break points and trace replay for both the program execution and physical system state simultaneously. This enables deeper insight into how changes in program execution affect the physical system and vice versa that can be used to debug and optimize operation. The key advantage of this invention is prior work does not offer a means of synchronizing external inputs (e.g., from video and other sensor data) with PLC execution tracing.

PLCs are widely used to control physical processes in industrial automation, but the practical solutions for debugging the effects of a PLC program on the physical world are limited. Well-known tools exist to capture values in PLC memory, add counters to the program, and timestamp data values. Several works have also explored strategies to record and replay PLC programs with minimal tracing overhead and to generate behavioral models of PLC programs for use as testing artifacts. However, none of these techniques readily allow the operator to associate the code execution with the physical process being controlled. Solutions outside of industrial automation, primarily developed for video game or web programming synchronize code execution with video playback for debugging applications, but they do not allow for modalities beyond screen capture. PLCs are typically used in an industrial automation setting where their primary responsibility is controlling a physical process. This includes various types of machines, ranging from robot arms that operate automatically without human intervention, to assembly line stages that position parts for assembly by humans. A key challenge in debugging systems that are tightly coupled to the physical world, is mapping the PLC program execution to its influence on the physical world. Prior work has explored tracing techniques that allow developers to record input/output traces that are already being fed into the PLC as part of the code, but they do not provide a general framework for capturing traces of information from the physical world to pair with the program trace.

There are several major challenges involved in creating a debugging system able to fuse digital and physical data. A first challenge is achieving tight synchronization between program execution and physical sensors that are often deployed across a distributed system. A second challenge is to instrument the program execution in a minimally invasive manner to avoid adversely impacting real-time performance. A third challenge is dealing with the volume of data generated by sensors like video cameras, which can be quite high. A fourth challenge is that physical triggers, such as providing images of certain situations, may need high-speed analytics that can identify states in the presence of sensor noise. This could be hand-crafted by an operator or performed programmatically by an anomaly detector. A fifth challenge is the presentation of data in an intuitive manner for developers and machine operators. The methodology of the present disclosure addresses these challenges, and is now discussed in further detail.

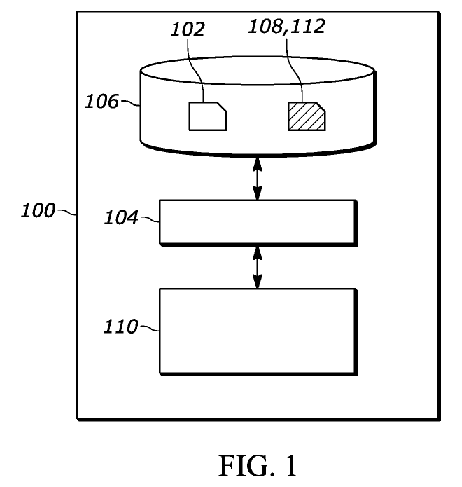

FIG. 1 shows a system 100 for training a neural network, e.g., a deep neural network. The neural network or deep neural networks shown and described are merely examples of the types of machine learning networks or neural networks that can be used. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an Ethernet or fiber optic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input an output of a previous layer, or for a first layer of the stack of layers, an initial activation, and a part of the input of the stack of layers. The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyper parameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

The system for training a neural network may be used in applications that include synchronizing sensor data with program trace data generated during the execution of a program by a PLC used to control an industrial process. For example, one or more machine-learning models may analyze the program execution and the sensor data and based thereon, determine where breakpoints can be generated for debugging the program. The model(s) may use data from a variety of sensors, either in the aggregate or separately to determine the changes in the various sensed parameters as the program executes, while also examining program trace data. The machine-learning model(s) may also aid in synchronizing sensor data to program execution based on how sensed quantities change as instructions are executed.

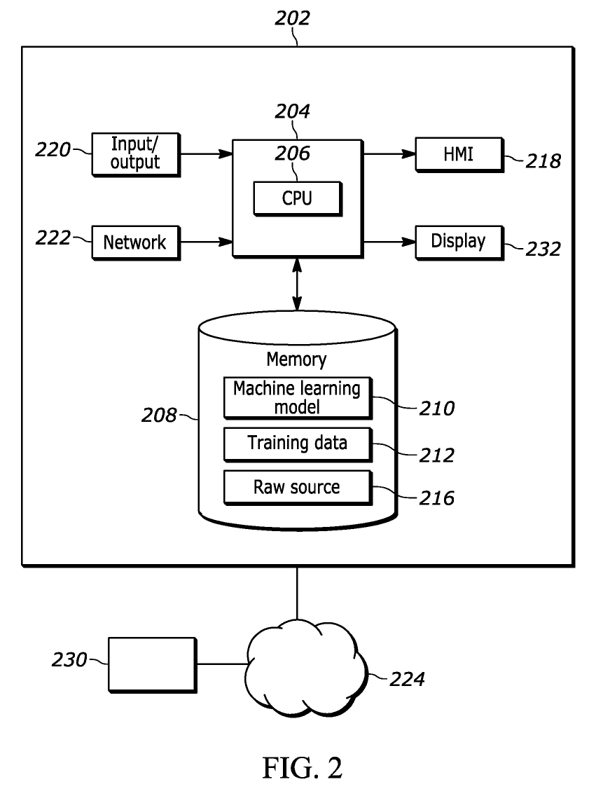

FIG. 2 depicts a system 200 to implement the machine learning models described herein, for example the deep neural networks used in, e.g., breakpoint generation of PLC programs, as described above. Other types of machine learning models can be used, and the DNNs described herein are not the only types of machine learning models capable of being used in the system of this disclosure. For example, if an input image associated with a process controlled by a PLC contains an ordered sequence of pixels after converting CSI values to pixels in an image), a CNN may be utilized. The system 200 can be implemented to perform one or more of the phases of image recognition described herein. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the ×86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation. While one processor 204, one CPU 206, and one memory 208 is shown in FIG. 2, of course more than one of each can be utilized in an overall system.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine learning model 210 or algorithm, a training dataset 212 for the machine learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 is used to transfer information between internal storage and external input and/or output devices (e.g., HMI devices). The I/O 220 interface can includes associated circuitry or BUS networks to transfer information to or between the processor(s) and storage. For example, the I/O interface 220 can include digital I/O logic lines which can be read or set by the processor(s), handshake lines to supervise data transfer via the I/O lines; timing and counting facilities, and other structure known to provide such functions. Examples of input devices include a keyboard, mouse, sensors, etc. Examples of output devices include monitors, printers, speakers, etc. The I/O interface 220 may include additional serial interfaces for communicating with external devices (e.g., Universal Serial Bus (USB) interface). The I/O interface 220 can be referred to as an input interface (in that it transfers data from an external input, such as a sensor), or an output interface (in that it transfers data to an external output, such as a display).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine learning algorithm 210 that is configured to analyze the raw source dataset 216. The raw source dataset 216 may include raw or unprocessed sensor data that may be representative of an input dataset for a machine learning system. The raw source dataset 216 may include video, video segments, images, text-based information, audio or human speech, time series data (e.g., a pressure sensor signal over time), raw or partially processed sensor data (e.g., radar map of objects), wireless signals in terms of CSI, RSSI, CIR. Moreover, the raw source dataset 216 may be input data derived from an associated sensor such as a camera, LiDAR, radar, ultrasonic sensor, motion sensor, thermal imaging camera, wireless receivers, or any other type of sensor that produces associated data with spatial dimensions where there is some notion of a “foreground” and a “background” within those spatial dimensions. References to an input or input “image” herein is not necessarily from a camera, but can be from any of the above-listed sensors. Other types of sensors, such as temperature and pressure sensors, may also provide various inputs to the system. Several different examples of inputs are shown and described with reference to the other drawings of the present disclosure. In some examples, the machine learning algorithm 210 may be a neural network algorithm (e.g., deep neural network) that is designed to perform a predetermined function. For example, the neural network algorithm may be configured to identify defects (e.g., cracks, stresses, bumps, etc.) in a part subsequent to the manufacture of that part but prior to leaving the plant.

The computer system 200 may store a training dataset 212 for the machine learning algorithm 210. The training dataset 212 may represent a set of previously constructed data for training the machine learning algorithm 210. The training dataset 212 may be used by the machine learning algorithm 210 to learn weighting factors associated with a neural network algorithm. The training dataset 212 may include a set of source data that has corresponding outcomes or results that the machine learning algorithm 210 tries to duplicate via the learning process.

The machine learning algorithm 210 may be operated in a learning mode using the training dataset 212 as input. The machine learning algorithm 210 may be executed over a number of iterations using the data from the training dataset 212. With each iteration, the machine learning algorithm 210 may update internal weighting factors based on the achieved results. For example, the machine learning algorithm 210 can compare output results (e.g., a reconstructed or supplemented image, in the case where image data is the input) with those included in the training dataset 212. Since the training dataset 212 includes the expected results, the machine learning algorithm 210 can determine when performance is acceptable. After the machine learning algorithm 210 achieves a predetermined performance level (e.g., 100% agreement with the outcomes associated with the training dataset 212), or convergence, the machine learning algorithm 210 may be executed using data that is not in the training dataset 212. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The trained machine learning algorithm 210 may be applied to new datasets to generate annotated data.

The machine learning algorithm 210 may be configured to identify a particular feature in the raw source data 216. The raw source data 216 may include a plurality of instances or input dataset for which supplementation results are desired. For example, the machine learning algorithm 210 may be configured to identify certain aspects of a manufacturing process carried out by automated equipment under control of a program executed by a PLC. In another example, the machine learning algorithm 210 may be configured to identify the presence of a defect in a manufactured part, produced by an automated process under control of a PLC program, by capturing images of that part. The machine learning algorithm 210 may be programmed to process the raw source data 216 to identify the presence of the particular features. The machine learning algorithm 210 may be configured to identify a feature in the raw source data 216 as a predetermined feature (e.g., obstacle, pedestrian, road sign, etc.). The raw source data 216 may be derived from a variety of sources. For example, the raw source data 216 may be actual input data collected by a machine learning system. The raw source data 216 may be machine generated for testing the system. As an example, the raw source data 216 may include raw video images from a camera.

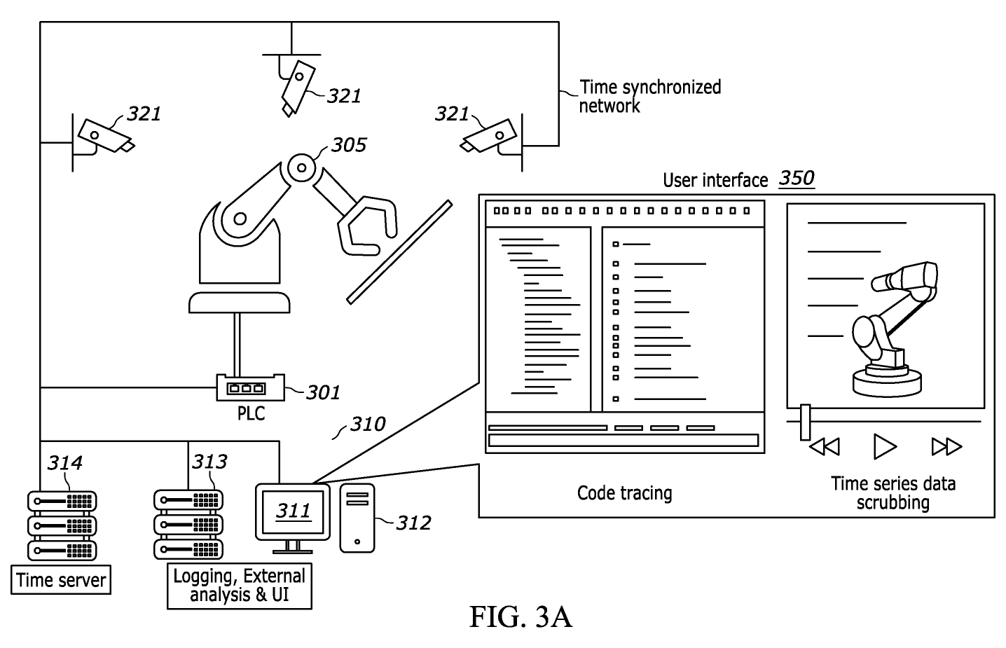

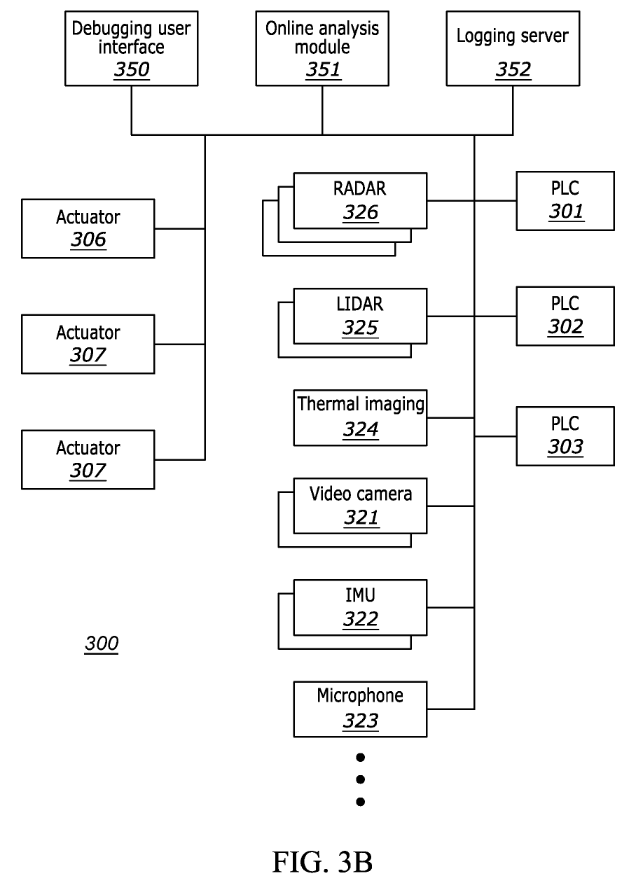

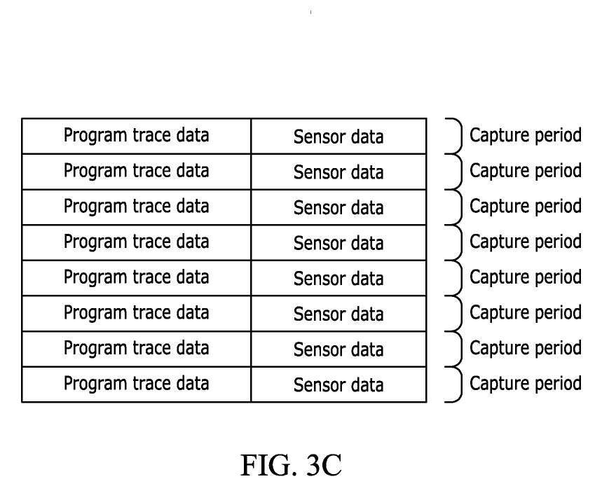

FIG. 3A shows a diagram of one embodiment of an industrial apparatus controlled by a PLC and a user interface for debugging a program executed by the PLC. As shown in FIG. 3A, a piece of industrial equipment 305 (a robotic arm in this example) is controlled using a PLC 301 executing an industrial program. A debugging system 310 as shown here includes a display 311 coupled to a computer system 312 (e.g., an industrial PC), and further coupled to a logging server 313 and a time server 314. Display 311 may present a user interface 350 to an operator, with the user interface presenting information regarding program trace data synchronized with sensor data, along with the ability to perform time series data scrubbing such that operator can quickly go to a point of interest in the program. A number of sensors 321 are also coupled to provide sensor input data into debugging system 310. In this particular example, the sensors 321 are video cameras, although the disclosure is not limited to these types of sensors. In contrast, in various implementations, debugging system 310 may receive data from a wide variety of sensors, including (in conjunction with or in lieu of the illustrated video cameras) sound and ultrasonic sensors, thermal imaging sensors, temperature sensors, pressure sensors, moisture sensors, and virtually any other type of sensor that can be used in an automated industrial process.

Among the functions carried out by debugging system include the synchronizing of program trace data with sensor data in order to enable the tight coupling of program code to physical responses of the system for debugging purposes. Time server 314 is configured to record timestamps for both program trace data resulting from program code executed by PLC 301, as well as for sensor data received from the various sensors. Logging server 313 may store timestamped data for further processing and/or transfer.

A challenge in augmenting PLC execution trace data with time-series data such as that produced by the various sensors is the managing of large volumes of data produced. For example, a single stream of high frame rate video data can quickly exceed the storage available locally on a PLC and exceed the capacity of an industrial PC such as computer system 312. Accordingly, various different mechanisms may be implemented to manage the volume of generated data. These mechanisms include providing warnings to a developer/operator that the logged data size will soon exceed the available memory/storage. This solution may limits costs and provide for short-term debugging sessions by developers, e.g., between factory shifts. Another possible mechanism is to store synchronized data on cloud server to increase storage capacity. Logging server 313 (which may be deployed on computer system 312 or may be separate therefrom) may compress and offload timestamped data to a database stored in a cloud server. Some embodiments may also utilize an analysis software module to identify anomalous situations and/or programmer-defined breakpoints in program execution indicating high value data, storing only this high value data for playback by the developer.

Computer system 312 may, using the timestamped information to synchronize the sensor data to the program trace data in order to provide an operator a more accurate picture of the cause-and-effect relationship between executed program code and the industrial process under control of PLC 301. To carry out the synchronization, computer system 312 may use sensor data captured during a capture period defined as the period in which sensor data is updated from a previous instance. This capture period can vary for one type of sensor data to another. For example, acoustic/sound data may change more rapidly than thermal data, and thus the capture period for the former may be shorter and more frequently updated than the latter. Upper and lower boundaries may be defined, with an upper boundary corresponding to a next consecutive given instance of the time-stamped program trace data and the lower boundary defined by a difference between the next consecutive given instance of the time-stamped program trace data and the capture period of sensor data. This can be defined by the formula (ti – Q) < tj < ti, as now explained in further detail.

As a program executes on PLC 301, logging server 313 (in conjunction with timestamps from time server 314) may capture all relevant multimodal time-series data, captured with period Q, and the PLC execution trace with period T. This assumes both the execution trace and the time-series sensor data are correctly time stamped on the device from which they are produced. To align the PLC program trace and the time-series sensor data, a post processing step associates PLC cycles with frames based on the following rule: a PLC execution cycle, cⱼ, with timestamp t_{j,} is associated with a time-series data point with timestamp tᵢ if (tᵢ – Q) < tⱼ < tᵢ, wherein Q is the capture period. Using the timestamps for the program trace data and the sensor data, computer system 312 may perform calculations using this formula to carry out the synchronization. When the time-series sensor data is played back by the operator during debug, execution cycles associated with each frame of sensor data will be displayed to the developer in the order they occurred. In some embodiments, to address the challenge of tight time synchronization for all timestamps, time synchronization may be carried out in compliance with IEEE Standard 1588 for precision clock synchronization (PTP). The overhead of PTP implementations in software can incur significant runtime overhead in low-end processors, so hardware support or a dedicated processor core should be used. Accordingly, computer system 312, in at least some embodiments, may be configured with sufficient processing power to carry out the time synchronization in compliance with IEEE standard 1588. However, the disclosure is not limited to such embodiments.

Generally speaking, the disclosure contemplates a synchronization methodology that leverages well-defined variable updates used in a PLC programming model to simplify the alignment of time-series data points and PLC execution. The PLC(s) may execute cyclically, repeatedly performing the defined computation within a period, T. The exact lines of code executed may change in correspondence with the input variables (e.g., from sensor data) to the PLC program. A PLC execution cycle may begin by reading in input variables and ends by writing out new values to external variables. As a result, the timestamp associated with any changes observed by external actuators may be a multiple of the period.

The synchronization/data-program alignment technique as disclosed herein may be orthogonal to the PLC tracing technique used, but may nevertheless benefit from techniques that record the minimum required data to replay a PLC program execution. These techniques may capture the variables at the beginning of each PLC cycle that could affect the output values at the end of the cycle. Further, this capture can be accelerated by hardware typically found in PLCs including field programmable gate arrays, FPGAs, with access to the primary computational core’s memory or by leveraging extra cores (e.g. in a multicore processor) to perform the recording outside of the real-time system’s critical path.

The synchronization techniques disclosed herein may also utilize machine learning. For example, machine learning may be used for breakpoint generation in the program execution. Identifying points at which the execution should pause for close investigation (typically called breakpoints) can be challenging, as a programmer/operator may need to map a physical phenomena (e.g., sensor data) to the program code. Machine learning may be utilized, based on user input of “fuzzy” breakpoints, to determine exact breakpoints. A “fuzzy” breakpoint may be defined by a user based on factors such as sensor values, variable values in a program, or any other useful information. A machine learning model may be executed to monitor and generate one or more breakpoints near these phenomena based on the user input. In some embodiments, machine learning may also use history of previously defined breakpoints and/or program execution history to determine breakpoints of interest for an operator. This may enable an operator performing debugging to highlight features of the multi-modal data streams that trigger (or may trigger) such breakpoints. The debugging interface may offer the feature of highlighting physical objects and/or sensor inputs and triggering a breakpoint based on the position/sensor value of the entity. Using the robotic arm example of FIG. 3A, an operator may be able to scrub to a point in a video feed of a robotic arm and highlight a point when the arm is grasping an object to inform the debugger to break on every grasp operation. Furthermore, the machine learning as described herein, may learn variable values input into the program that lead up to such grasp operations and generate one or more breakpoints associated therewith.

FIG. 3B shows a block diagram of one embodiment of a system for debugging a control program executable by a PLC. System 300 as shown in FIG. 3B includes a debugging user interface 350, an online analysis module 351, and a logging server 352. These components are coupled to PLCs 301, 302, and 303. The particular number of PLCs used in a given embodiment may vary, being as few as one, but may be any feasible plural number. A number of actuators 306 are also part of system 300. The actuators may respond to various commands generated by the execution of control programs on the one or more PLCs. For example, the robot arm depicted in FIG. 3A may include a number of actuators to control its movement in accordance with commands resulting from the execution of a control program. The number and type of actuators 306 may vary from one embodiment to another. The disclosure contemplates actuators that generate various types of physical responses, such as mechanical motion, thermal output, sonic output, light and/or electromagnetic output, and so on.

System 300 as shown here includes a number of different sensors. These sensors include radar 326, LiDAR 325, thermal imaging sensor 324, video camera 321, inertial measurement unit (IMU) 322, and microphone 323. These sensors are examples, and the disclosure is not limited to just these types. Other types include temperature sensors, sonic and ultrasonic sensors (e.g., to determine sound levels), pressure sensors, liquid flow rate sensors, among others. A given implementation of system 300 may include any suitable number and combination of sensors of various types.

Debugging interface 350 may be the same or similar to that shown in FIG. 3A, allowing an operator to view the synchronized data, including the code tracing and corresponding sensor data, thus allowing a view of the cause-effect relationship between the two. Furthermore, debugging interface 350 allows for time-series data scrubbing to allow an operator to quickly move between parts of the program execution.

The debugging interface 350 may, in various implementations, combine features utilized in integrated development environments associated with other types of environment, such as those of code and video editing software. Accordingly, debugging interface 350 includes linked code step-through and data sequence scrubbing. This may allow operators to step through the program, instruction by instruction, and observe changes in variables. Similarly, as video editors require the ability to scroll through the video input to quickly select points in time, debugging interface 350 of the present disclosure links code stepping and times-series data scrubbing. In such linked stepping/scrubbing, both the code and the data streams are displayed side by side. Thus, when the programmer/operator steps through the code, the data streams advance correspondingly. Similarly, if a programmer/operator scrubs through the data stream in time, the code steps advance.

Debugging interface 350 may also enable variable highlighting in response to a data sequence selection. Given side-by-side display of the code and data streams, a programmer/operator may select start and end points in the data streams, with debugging interface correspondingly highlighting points in the code where variables changed values during the selected window. This may allow a programmer/operator to observe the flow of data through the flow of the program execution that caused the corresponding changes in the physical world.

Online analysis module 351 may reduce the amount of time series data that must be stored by identifying sections of interest in the data. Defining anomalies to be recorded by the debugging system may be challenging. Analysis module 351 may utilize one or more approaches in carrying out such identification. In one approach, to reduce the computational overhead of finding regions of interest in the code/data, the system could use a single modality or type of sensor data to determine interesting sections of all the time series data in the system. For example, high frequency video processing capable of identifying movement could demarcate the important regions for multiple sensors using input from a single camera.

In another approach, analysis module 351 may trigger based on conventional watch points defined by the programmer/operator. For instance, the analysis module can trigger based on a combination of input values to the actuators or output values from the actuators and/or sensor. If the analysis module 351 is provided access to the PLC execution trace, it could also trigger based on variables internal to the PLC program execution. These watch points could also be exposed on the network, triggered by messages in various protocols.

The various software-based approaches discussed above may also utilize machine learning as discussed elsewhere herein.

To reduce the performance penalty of carrying out the analysis purely in software, hardware implementations are possible. These hardware implementations may include the coalescing of hardware resources, including FPGAs, GPUs, DSPs or NPUs on the logging server 352 to perform high speed processing at one point in the network. Hardware-based approaches may also include augmenting sensors in the network to co-locate data collection and processing.

FIG. 3C shows a portion of a user interface linking executed PLC code and sensor data within a period of capture of the sensor data. The example shown here includes program trace data that is linked to sensor data that is captured during a capture period. As noted above, a capture period is defined by a rate at which sensor data from a particular sensor is updated. For example, a sensor may update ever one millisecond (1 ms), and thus its capture period is 1 ms.

The sensor data in each line shown in FIG. 3C is paired with program trace data from one or more lines of code that executed during the capture period. Such a display allows a programmer/operator to quickly ascertain cause and effect relationships between executing code and physical responses of the system under control of the program from which the code was executed. Presenting this data in sequential form may also provide additional insight, as a programmer/operator may be able to observe how the response of the system evolves over time in accordance with executed code.

The ability to tightly pair the executed code with corresponding sensor data may allow for more effective debugging of a PLC program used to control an industrial process. More particularly, a user interface presenting program trace data and corresponding sensor data that is tightly synchronized in the manner presented herein may enable a programmer/operator to more quickly hone in on problem areas of the code and thus make changes such that the industrial process is carried out in the desired manner.

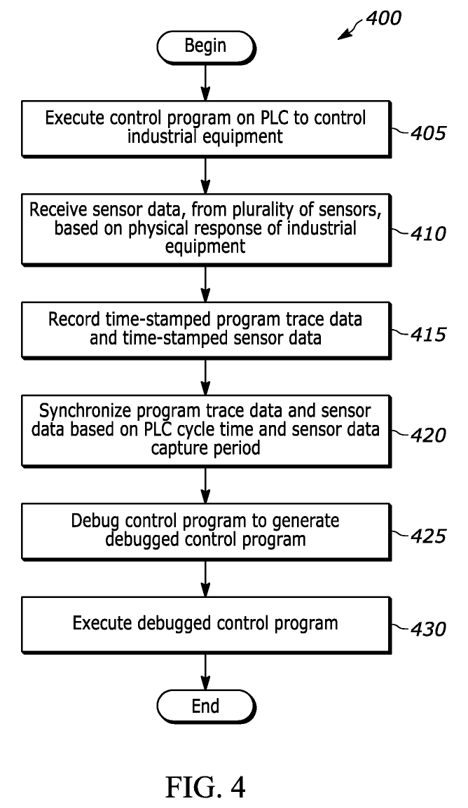

FIG. 4 illustrates an example method for synchronizing sensor data and program trace data in a system for debugging a control program executable by a PLC. Method 400 may be carried out by various embodiments of the systems discussed elsewhere herein. Moreover, any embodiment of a system capable of carrying out Method 400 is considered to fall within the scope of this disclosure.

Method 400 includes executing a control program on a PLC to control industrial equipment (block 405). The industrial equipment operating under control of the PLC may be used to carry out an industrial process, such as manufacturing a product or performing part of a product assembly, materials processing, chemical processing, and virtually any other type of industrial process that may be carried out under the control of a PLC. Method 400 further includes receiving sensor data, from a plurality of sensors, based on physical responses of the industrial equipment (block 410). The sensor data may be raw data received from any number or type of sensors, including (but not limited to) those examples given elsewhere herein. As the program executes and the sensor data is received, Method 400 further includes recording time-stamped program trace data and time-stamped sensor data (block 415).

Using the time-stamped program trace data and time-stamped sensor data, Method 400 continues by synchronizing the former to the latter based on both a PLC cycle time (e.g., based on a rate at which instructions execute) and a capture period (e.g., based on a rate at which sensor data is updated; block 420). The synchronization may be carried out as discussed above. More particularly, a PLC execution cycle, cⱼ, with timestamp t_{j,} is associated with a time-series data point with timestamp tᵢ if (tᵢ – Q) < tⱼ < tᵢ, wherein Q is the capture period. Using this methodology, each instance of program trace data may be associated with an instance of sensor data, and vice versa.

The synchronized data may be presented in a user interface. The presentation of this data allows a programmer/operator to debug the control program to generate a debugged control program (block 425). Thereafter, the debugged control program may be executed (block 430), and the programmer/operator may determine if further debugging is necessary. More particularly, the programmer/operator may observe the industrial process and the results thereof to determine if they are satisfactory, and performing additional debugging if further refinements are desired.

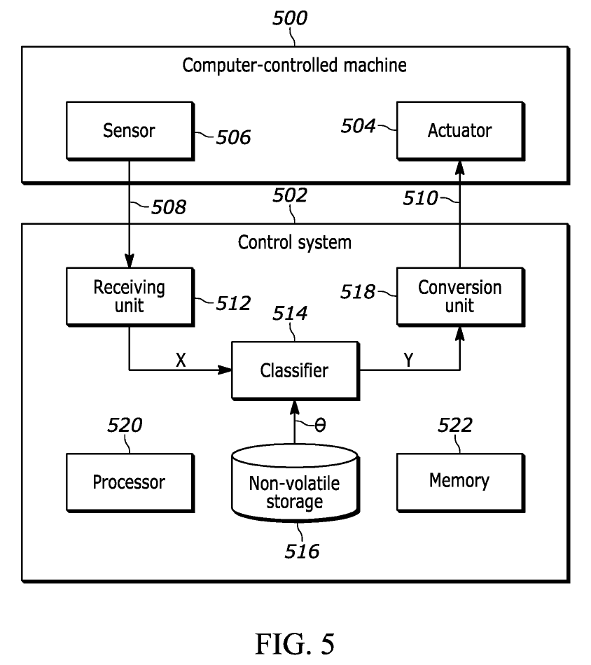

FIG. 5 depicts a schematic diagram of an interaction between a computer-controlled machine 500 and a control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500 or a process carried out thereby. Sensor 506 may be configured to encode the sensed condition into sensor signals 508 and to transmit sensor signals 508 to control system 502. Non-limiting examples of sensor 506 include wireless receivers, video, radar, LiDAR, sonic and ultrasonic sensors, motion sensors, temperature sensors, pressure sensors, and thermal imaging sensors, as described above with reference to FIGS. 1-2. Embodiments in which a combination of different sensors are possible and contemplated.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500. Control system 502 may include a PLC as discussed elsewhere herein, while computer-controlled machine 500 may be industrial equipment configured to carry out an automated industrial process.

As shown in FIG. 5, control system 502 also includes processor 520 and memory 522. Processor 520 may include one or more processors, and at least one of these processors may comprise a PLC. Memory 522 may include one or more memory devices. The classifier 514 (e.g., machine learning algorithms, such as those described above with regard to pre-trained classifier 306) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more ML algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C #, Objective C, Fortran, Pascal, Java Script, Python, Perl, and PL/SQL.

Upon execution by processor 520, the computer-executable instructions of non-volatile storage 516 may cause control system 502 to implement one or more of the ML algorithms and/or methodologies as disclosed herein. Non-volatile storage 516 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as PLCs, Application Specific Integrated Circuits (ASICs), Field-Programmable Gate Arrays (FPGAs), state machines, controllers or other hardware components or devices, or a combination of hardware, software and firmware components.

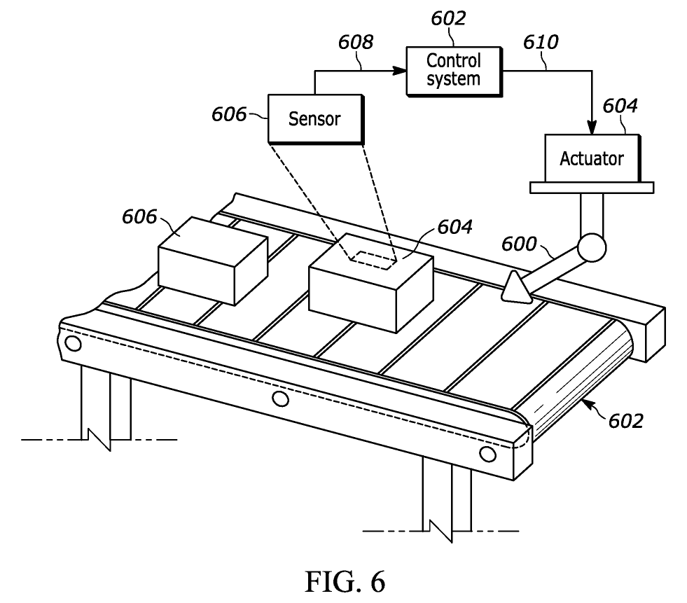

FIG. 6 depicts a schematic diagram of control system 502 configured to control system 600 (e.g., manufacturing machine), such as a punch cutter, a cutter or a gun drill, of manufacturing system 602, such as part of a production line. Control system 502 may be configured to control actuator 504, which is configured to control system 600 (e.g., manufacturing machine). In this example, manufacturing system 602 is a conveyer belt. However, this example is not intended to be limiting, as the disclosure contemplates a wide variety of manufacturing systems and related equipment.

Sensor 506 of system 600 (e.g., manufacturing machine) may be an optical sensor (such as those described above) configured to capture one or more properties of manufactured product 604. Classifier 514 may be configured to determine a state of manufactured product 604 from one or more of the captured properties. Actuator 504 may be configured to control system 600 (e.g., manufacturing machine) depending on the determined state of manufactured product 604 for a subsequent manufacturing step of manufactured product 604, or for binning the manufactured product 604 (e.g., discard, sorting, marking, trimming, or repair) if the manufactured product 604 has a detected defect. The actuator 504 may be configured to control functions of system 600 (e.g., manufacturing machine) on subsequent manufactured product 606 of system 600 (e.g., manufacturing machine) depending on the determined state of manufactured product 604.

Control system 502 may include, in various implementations, a PLC that executes a program to control an industrial process. The sensor 506 may be any type of sensor (and may further encompass multiple sensors of different types) that provide input data to control system 502. Actuator may be virtually any type of mechanism that, under the control of control system 502, causes various types of physical responses in the controlled process (e.g., the movement/speed of the conveyor belt). Control system 502 may further incorporate) various functions such as those discussed above for the purpose of synchronizing program trace data to sensor responses for the purpose of debugging and refining a control program.

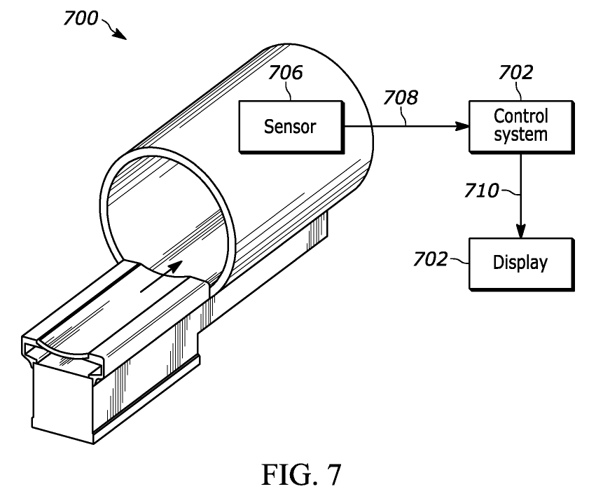

FIG. 7 depicts a schematic diagram of control system 502 configured to control imaging system 700, for example a Mill apparatus, x-ray imaging apparatus or ultrasonic apparatus. Sensor 506 may, for example, be an imaging sensor. Control system 502 may use raw imaging data generated by sensor 506 to both control operation of imaging system 700 as well as to determine information to be shown in display 702. Control system 502 may incorporate a PLC configured to execute a control program. Additional functionality to enable synchronizing program trace data with sensor data may also be incorporated into control system 502, in a manner similar to the other examples presented herein.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

WHAT IS CLAIMED IS:

1. A method for synchronizing sensor data from an industrial process with program trace data from a control program executed by a programmable logic controller (PLC) controlling the industrial process, the method comprising:
executing a control program, using the PLC, to control industrial equipment and cause physical responses in the industrial equipment;
receiving sensor data based on the physical responses in the industrial equipment, from a plurality of sensors, wherein the plurality of sensors include at least one sensor configured to provide streaming data, and one or more additional sensors configured to sense physical data;
recording program trace data from the control program and sensor data from each of the plurality of sensors, wherein the program trace data and the sensor data are time-stamped, and wherein the sensor data is periodically recorded in a capture period;
synchronizing instances of the time-stamped program trace data and instances of the time-stamped sensor data, wherein the synchronizing comprises:
determining, for a given instance of the time-stamped program trace data, that the given instance of the program trace data is within a time period having an upper boundary corresponding to a next consecutive given instance of the time-stamped program trace data and a lower boundary defined by a difference between the next consecutive given instance of the time-stamped program trace data and the capture period of sensor data for a corresponding one of the plurality of sensors; and
linking an instance of the time-stamped sensor data within upper and lower boundaries to the time-stamped program trace data within the upper and lower boundaries;
debugging the control program to generate a debugged control program, wherein debugging the control program includes presenting instances of the synchronized data to a user via a debugger interface; and
executing the debugged control program.

2. The method of claim 1, further comprising generating one or more break points in the control program based on a plurality of streams of sensor data.

3. The method of claim 2, further comprising executing a machine learning model to identify the one or more break points.

4. The method of claim 1, wherein the capture period at which sensor data is recorded is less than a cycle time at which the PLC generates outputs from executing the control program.

5. The method of claim 1, wherein recording program trace data from the control program and sensor data from each of the plurality of sensors comprises storing the program trace data and the sensor data in a remote server.

6. The method of claim 1, wherein recording program trace data from the control program and sensor data from each of the plurality of sensors comprises storing program trace data and sensor data corresponding to one or more user-defined breakpoints, one or more anomalies, and further comprises discarding program trace data not associated with the one or more user-defined breakpoints or one or more anomalies.

7. The method of claim 1, further comprising presenting the debugger interface displaying synchronized instances of the time-stamped program trace data and instances of the time-stamped sensor data.

8. The method of claim 7, further comprising scrubbing through a sequence of the time-stamped program trace data and instances of the time-stamped sensor data.

9. The method of claim 7, further comprising the debugger interface presenting highlights of variable changes in the time-stamped sensor data.

10. The method of claim 1, wherein the sensor data comprises one or more of the following:
LiDAR data;
radar data;
sound data;
thermal data;
inertial measurement unit data;
video data.

11. A non-transitory computer readable medium storing instructions thereon that, when executed on a computing system, cause the computer system to carry out operations including:
synchronizing sensor data from an industrial process with program trace data from a control program executed by a programmable logic controller (PLC) controlling the industrial process, wherein the synchronizing comprises:
executing a control program, using the PLC, to control industrial equipment and cause physical responses in the industrial equipment;
receiving sensor data based on the physical responses in the industrial equipment, from a plurality of sensors, wherein the plurality of sensors include at least one sensor configured to provide streaming data, and one or more additional sensors configured to sense physical data;
recording program trace data from the control program and sensor data from each of the plurality of sensors, wherein the program trace data and the sensor data are time-stamped, and wherein the sensor data is periodically recorded in a capture period;
synchronizing instances of the time-stamped program trace data and instances of the time-stamped sensor data, wherein the synchronizing comprises determining, for a given instance of the time-stamped program trace data, that the given instance of the program trace data is within a time period having an upper boundary corresponding to a next consecutive given instance of the time-stamped program trace data and a lower boundary defined by a difference between the next consecutive given instance of the time-stamped program trace data and the capture period of sensor data for a corresponding one of the plurality of sensors;
linking an instance of the time-stamped sensor data within upper and lower boundaries to the time-stamped program trace data within the upper and lower boundaries;
presenting instances of the synchronized data to a user via a debugger interface to enable a user to debug the control program in order to generate a debugged control program; and
executing the debugged control program.

12. The computer readable medium of claim 11, wherein the operations further includes generating one or more break points in the control program based on a plurality of streams of sensor data.

13. The computer readable medium of claim 12, wherein the operations further include executing a machine learning model to identify the one or more break points.

14. The computer readable medium of claim 11, wherein a capture period at which sensor data is recorded is less than a cycle type at which the PLC generates output from executing the control program.

15. The computer readable medium of claim 11, wherein recording program trace data from the control program and sensor data from each of the plurality of sensors comprises storing program trace data and sensor data corresponding to one or more user-defined breakpoints, one or more anomalies, and further comprises discarding program trace data not associated with the one or more user-defined breakpoints or one or more anomalies.

16. The computer readable medium of claim 11, wherein the operations further include displaying synchronized instances of the time-stamped program trace data and instances of the time-stamped sensor data on the debugger interface.

17. The computer readable medium of claim 16, wherein the operations further include the debugger interface presenting highlights of variable changes in the time-stamped sensor data.

18. The computer readable medium of claim 11, wherein the operations further includes recording one or more of the following types of sensor data:
LiDAR data;
radar data;
sound data;
thermal data;
inertial measurement unit data;
video data.

19. A system for controlling an automated industrial process, the system comprising:
a programmable logic controller (PLC) configured to execute a control program to control industrial equipment carrying out the industrial process, and further configured to cause physical responses in the industrial equipment;
a computer system coupled to the PLC, wherein the computer system is configured to:
receive, from a plurality of sensors, sensor data based on the physical responses in the industrial equipment, wherein the plurality of sensors include at least one sensor configured to provide streaming data, and one or more additional sensors configured to sense physical data;
record program trace data from the control program and sensor data from each of the plurality of sensors, wherein the program trace data and the sensor data are time-stamped, and wherein the sensor data is periodically recorded in a capture period;
synchronize instances of the time-stamped program trace data and instances of the time-stamped sensor data, wherein the synchronizing comprises:
determining, for a given instance of the time-stamped program trace data, that the given instance of the program trace data is within a time period having an upper boundary corresponding to a next consecutive given instance of the time-stamped program trace data and a lower boundary defined by a difference between the next consecutive given instance of the time-stamped program trace data and the capture period of sensor data for a corresponding one of the plurality of sensors; and
linking an instance of the time-stamped sensor data within upper and lower boundaries to the time-stamped program trace data within the upper and lower boundaries; and
present a debugging interface for debugging the control program to generate a debugged control program, wherein presenting the debugging interface includes presenting instances of the synchronized data to a user via a debugger interface, wherein the PLC is further configured to execute the debugged control program.

20. The system of claim 19, wherein the computer system is further configured to:
execute a machine learning model to identify, based on a plurality of streams of sensor data, one or more break points in the control program, and further configured to generate the one or more break points during execution of the control program.
